(19) United States
(12) Patent Application Publication
(10) Pub. No.: US 2011/0045171 A1
(43) Pub. Date: Feb. 24, 2011

(54) Multi-Step Method to Selectively Deposit Ruthenium Layers of Arbitrary Thickness on Copper

(75) Inventors: Fenton Read McFeely, Yorktown Heights, NY (US); Chih-Chao Yang, Albany, NY (US); John Jcobs Yurkas, Yorktown Heights, NY (US)

Correspondence Address: MICHAEL J. CHANG, LLC, 84 SUMMIT AVENUE, MILFORD, CT, 06460, US

(73) Assignee: International Business Machines Corporation, Armonk, NY (US)

(21) Appl. No.: 12/544,110

(22) Filed: Aug. 19, 2009

(51) Int. Cl. B05D 5/12

(52) U.S. Cl. 427/96.8

(57) ABSTRACT

Techniques for forming a ruthenium (Ru) capping layer on a copper (Cu) wire are provided. In one aspect, a method of forming a Ru capping layer on at least one exposed surface of a Cu wire embedded in a dielectric structure includes the following steps. A first Ru layer is selectively deposited onto the Cu wire and the dielectric structure by chemical vapor deposition (CVD) for a period of time during which selective nucleation of the Ru occurs on the surface of the Cu wire. Any nucleated Ru present on the dielectric structure is oxidized. The oxidized Ru and an aqueous acid are contacted to remove the oxidized Ru from the dielectric structure based on a selectivity of the aqueous acid in dissolving the oxidized Ru. A second Ru layer is selectively deposited onto the first Ru layer by CVD to produce a thicker Ru layer. The steps of oxidizing and contacting the oxidized Ru and an aqueous acid are repeated until a Ru layer having a thickness that is suitable for use as a Ru capping layer on at least one exposed surface of the Cu wire embedded in the dielectric structure is achieved.

### FIELD OF THE INVENTION

The present invention relates to wiring structures and more particularly, to techniques for forming a ruthenium (Ru) capping layer over a copper (Cu) wire.

### BACKGROUND OF THE INVENTION

Copper (Cu) wires are generally formed by first patterning a dielectric, e.g., using photolithography, with a layout of the wires. A diffusion barrier layer is deposited in the pattern. The pattern is filled with Cu to form the wires. A capping layer is then deposited over the wires, which serves to protect the wires during subsequent processing. In conventional configurations, the capping layer typically comprises a layer of dielectric over the wires.

From the standpoint of electromigration, however, ruthenium (Ru) as a capping layer for Cu wires provides improved performance over the conventional dielectric capping layer. Unfortunately, one obstacle to the use of Ru as a capping layer is that during deposition of the Ru over the Cu wires, the dielectric can become contaminated with the Ru. It is essential to avoid contaminating the dielectric with Ru as this can lead to electrical leakage through the dielectric and the formation of short circuits. Chemical vapor deposition (CVD) is the best known method for depositing Ru over Cu wires. CVD, however, has only limited selectivity with respect to deposition of the Ru on the Cu wire, as compared to on the dielectric.

Therefore, techniques for depositing a Ru capping layer over a Cu wire, without contaminating the dielectric would be desirable.

### SUMMARY OF THE INVENTION

The present invention provides techniques for forming a ruthenium (Ru) capping layer on a copper (Cu) wire. In one aspect of the invention, a method of forming a Ru capping layer on at least one exposed surface of a Cu wire embedded in a dielectric structure is provided. The method includes the following steps. A first Ru layer is selectively deposited onto the Cu wire and the dielectric structure by chemical vapor deposition (CVD) for a period of time during which selective nucleation of the Ru occurs on the surface of the Cu wire. Any nucleated Ru present on the dielectric structure is oxidized. The oxidized Ru and an aqueous acid are contacted to remove the oxidized Ru from the dielectric structure based on a selectivity of the aqueous acid in dissolving the oxidized Ru. A second Ru layer is selectively deposited onto the first Ru layer by CVD to produce a thicker Ru layer. The step of oxidizing and the step of contacting the oxidized Ru and an aqueous acid are repeated until a Ru layer having a thickness that is suitable for use as a Ru capping layer on at least one exposed surface of the Cu wire embedded in the dielectric structure is achieved.

A more complete understanding of the present invention, as well as further features and advantages of the present invention, will be obtained by reference to the following detailed description and drawings.

### BRIEF DESCRIPTION OF THE DRAWINGS

FIGS. 1A-E are cross-sectional diagrams illustrating an exemplary methodology for forming a ruthenium (Ru) capping layer on a copper (Cu) wire according to an embodiment of the present invention; and

FIG. 2 is a graph illustrating x-ray photoemission spectroscopy (XPS) analysis results of a sample dielectric according to an embodiment of the present invention.

### DETAILED DESCRIPTION OF PREFERRED EMBODIMENTS

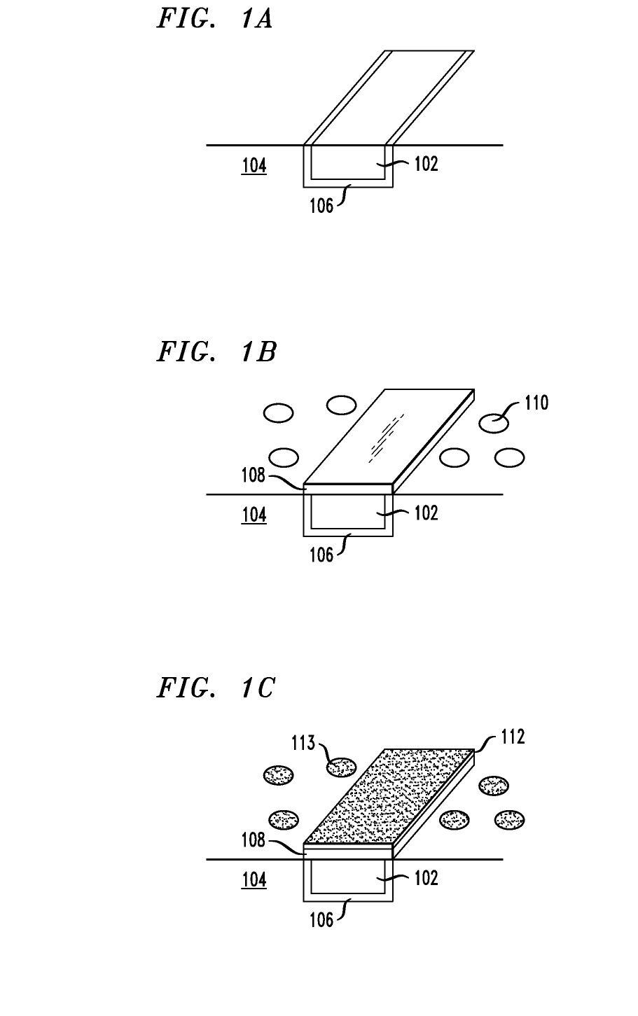

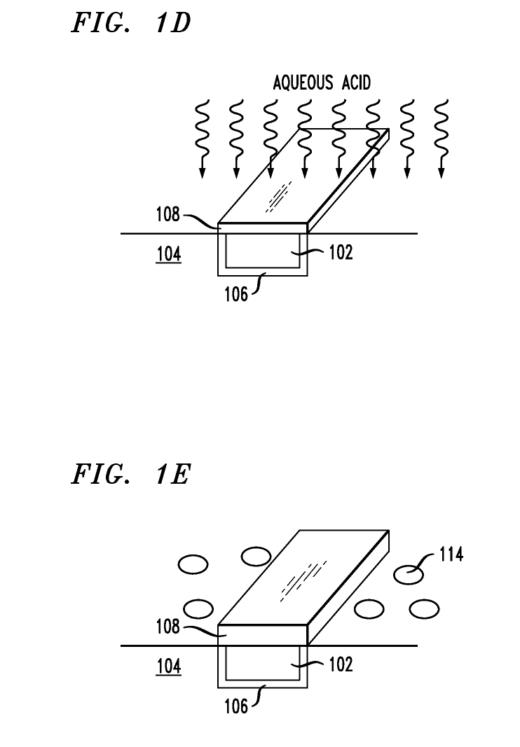

FIGS. 1A-E are cross-sectional diagrams illustrating an exemplary methodology for forming a ruthenium (Ru) capping layer on a copper (Cu) wire. As shown in FIG. 1A, Cu wire 102 is embedded in dielectric structure 104. Dielectric structure 104 preferably comprises a low-k dielectric, such as a SiCOH low-k dielectric. Diffusion barrier layer 106 is present between Cu wire 102 and dielectric structure 104. According to the present techniques, a Ru capping layer will be formed on the exposed, i.e., top, surface of Cu wire 102. As highlighted above, a capping layer is typically used to protect the wire during subsequent processing. Advantageously, the capping layers described herein (i.e., Ru capping layers over Cu wires) further serve to suppress electromigration of the Cu in the wire.

As shown in FIG. 1B, Ru layer 108 is formed on Cu wire 102. Specifically, chemical vapor deposition (CVD) of Ru is performed for a duration of which there is preferential selective nucleation of the Ru on the surface of Cu wire 102 as compared to on dielectric structure 104, to form Ru layer 108. Ru layer 108 may, or may not, extend over diffusion barrier layer 106 to some degree. See, for example, FIG. 1B wherein Ru layer 108 extends over diffusion barrier layer 106. Whether or not Ru layer 108 extends over diffusion barrier layer 106 depends on the degree to which the selective nucleation of the Ru observed to occur on Cu also occurs on the exposed surface of diffusion barrier layer 106. However, the degree, if any, to which diffusion barrier layer 106 is covered by Ru layer 108 has no effect on the efficacy of the present capping layer or techniques for formation thereof. Thus, either case would be equally acceptable.

According to an exemplary embodiment, the Ru CVD is performed in a vacuum chamber (which can be, but is not required to be, a multi-chamber system) containing a Ru CVD reactor. Prior to the Ru deposition, Cu wire 102 may optionally be subjected to a cleaning treatment to remove oxide from the exposed surfaces thereof. The cleaning treatment can include, but is not limited to, heating the Cu wire and dielectric structure in a vacuum, exposing the structure to a reducing gas (such as molecular hydrogen) and/or sputtering the surface of Cu wire 102 with an inert gas ion beam to physically remove a surface oxide layer. Such cleaning treatments are known to those of skill in the art and thus are not described further herein. The Cu wire and dielectric structure is then inserted into the Ru CVD reactor and brought to a temperature of about 180 degrees Celsius (° C.) (with a deposition pressure of about 10 milliTorr (mtorr)) and exposed to a precursor gas stream comprising, for example, Ru₃(CO)₁₂ (a Ru carbonyl precursor), carbon monoxide (CO) and argon (Ar).

Ru CVD exhibits limited selectivity for deposition of Ru on Cu wire 102 over deposition on dielectric structure 104 (a low-k dielectric, see above). This selectivity depends on the difference in the induction times for the Ru to nucleate on the two different materials. On Cu the Ru begins to nucleate immediately, thus the induction time is essentially zero (to within experimental error). As such, Ru layer 108 begins to grow immediately on Cu wire 102 and wets the surface well. By contrast, under typical deposition conditions (i.e., such as those exemplary deposition conditions presented above) it takes about 30 seconds before scattered Ru nuclei 110 begin to form on dielectric structure 104. During this period, it is possible to deposit Ru layer 108 to an arbitrary thickness, e.g., from about two nanometer (nm) to about 2.5 nm on the surface of Cu wire 102. However, for the manufacture of a robust capping layer, a thickness of from about five nm to about 10 nm is desired. Thus, as will be described in detail below, the deposition process can be repeated x number of times until Ru layer 108 achieves a desired thickness. Therefore, the term “arbitrary thickness” makes reference to the fact that since the Ru layers deposited in each iteration of the process are less than the desired final thickness, the thickness of the Ru layer formed in each deposition is generally not important.

It is notable that the thickness of the Ru layer deposited as described above can vary depending, for example, on the exact nature of the reactor and/or exact chemical nature of the dielectric. For example, the lower the dielectric constant (of the dielectric), the more selective the process is for Ru deposition on the Cu wire versus on the dielectric.

As shown in FIG. 1C, the Ru nuclei that have formed on dielectric structure 104 are oxidized. The present techniques make use of the fact that metallic Ru is unaffected by aqueous acids, while ruthenium oxide (RuO₂) is dissolved and removed by such aqueous acids. Therefore, after Ru layer 108 is deposited to a thickness of from about two nm to about 2.5 nm (see above), the Cu wire and dielectric structure is removed from the vacuum chamber and exposed to the atmosphere. This exposure will oxidize any dispersed Ru nuclei present on dielectric structure 104, along with a thin surface layer of Ru layer 108, approximately one atomic layer (one monolayer) thick (i.e., approximately 0.3 nm, based on the atomic radius of Ru) forming oxidized Ru nuclei 113 and oxidized monolayer 112, respectively. A more vigorous oxidation process, such as heating the structure to a temperature of less than about 100° C. in an oxygen-containing environment, or treatment with an aqueous oxidizing agent such as dilute hydrogen peroxide (e.g., 30 percent (%) aqueous hydrogen peroxide, diluted by about 100:1 in deionized water) may also be employed. However, it has been found that a more vigorous oxidation process is generally not needed when the deposition is interrupted at a time when only minimal Ru is present on the dielectric (the amount that accumulates in the 30 second period using the CVD set-up described herein).

As shown in FIG. 1D, an aqueous acid is used to remove the oxidized Ru. The aqueous acid preferably comprises a mineral acid, such as hydrofluoric acid (HF) diluted from about 10:1 to about 100:1 in deionized water. As highlighted above, metallic Ru is unaffected by aqueous acids, while RuO₂ is dissolved and removed by such aqueous acids. The aqueous acid will remove oxidized Ru nuclei 113 present on dielectric structure 104, along with oxidized monolayer 112 of Ru layer 108. According to an exemplary embodiment, to remove the oxidized Ru, the Cu wire and dielectric structure is placed in an acid bath containing the dilute HF. The structure is then re-introduced into the CVD vacuum chamber and treated with molecular hydrogen to reduce any oxide that might have formed on the surface of Ru layer 108 (not shown) when the structure is removed from the acid bath and the clean Ru surface is re-exposed to air.

Then, as shown in FIG. 1E, another round of Ru CVD is performed to increase the thickness of Ru layer 108. Namely, another CVD of Ru is performed for a duration (e.g., 30 seconds) of which there is preferential nucleation of the Ru on Ru layer 108 as compared to on dielectric structure 104. As such, the thickness of Ru layer 108 can be increased to, e.g., from about four nm to about five nm. As highlighted above, during the Ru deposition some scattered Ru nuclei 114 can form on dielectric structure 104. The steps described in conjunction with the description of FIGS. 1C-D are then repeated to oxidize and remove Ru nuclei 114 from dielectric structure 104. The steps described in conjunction with the descriptions of FIGS. 1C-E can be repeated any number of times until Ru layer 108 attains a desired thickness (see above).

The present teachings are further described way of the following non-limiting example: a SiCOH dielectric sample, with k value approximately 2.2 was placed in a CVD reactor and exposed at 180° C. to Ru₃(CO)₁₂ precursor. The sample was then cooled and removed from the reactor, and introduced into an x-ray photoemission spectrometer (XPS) for analysis.

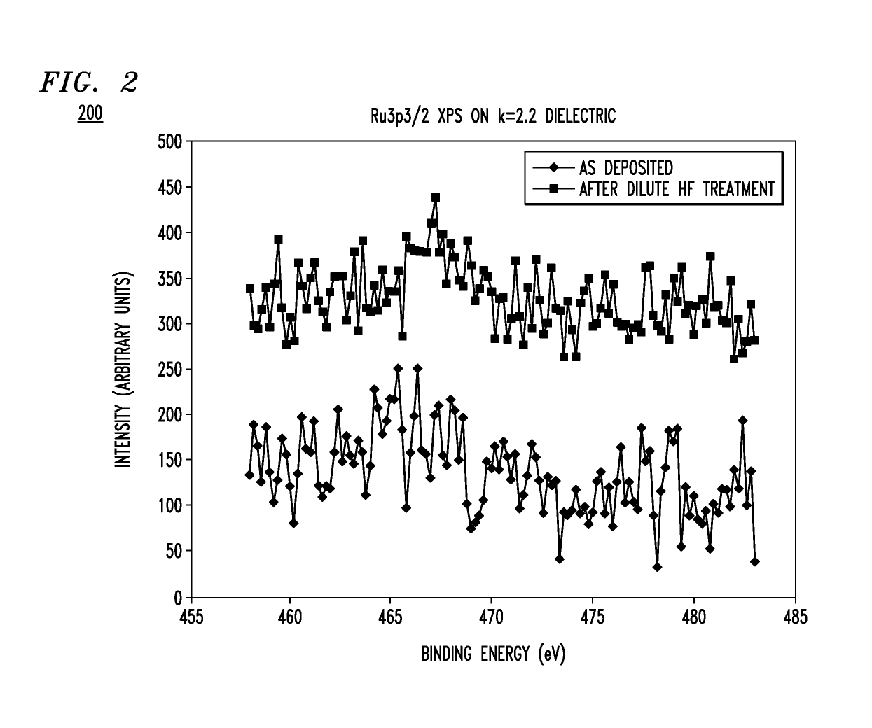

FIG. 2 is graph 200 illustrating the XPS analysis results. In graph 200, binding energy (measured in electron volts (eV)) is plotted as a function of intensity. The top curve of graph 200 shows the Ru 3p^{3/2} region of the spectrum obtained from this sample. A weak peak at 468 eV is observed. The intensity of this peak is consistent with about one % of a monolayer of Ru being present on the dielectric, that is, it is the same intensity as would be produced by a film one atomic layer of Ru in thickness covering one % of the surface of the dielectric.

The sample was then removed from the XPS spectrometer and immersed in 100:1 dilute HF for one minute, rinsed in distilled water, air dried, re-immersed in the dilute HF, re-rinsed and re-dried. The sample was reintroduced into the XPS spectrometer and the spectrum from the lower curve of graph 200 was obtained. The results show a level of Ru contamination reduced to below the detection limit of the technique. Thus the incipient Ru nuclei, which give rise to the unwanted deposition the dielectric, have been removed.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method of forming a ruthenium capping layer on at least one exposed surface of a copper wire embedded in a dielectric structure, the method comprising the steps of:
selectively depositing a first ruthenium layer onto the copper wire and the dielectric structure by chemical vapor deposition for a period of time during which selective nucleation of the ruthenium occurs on the surface of the copper wire;
oxidizing any nucleated ruthenium present on the dielectric structure;
contacting the oxidized ruthenium and an aqueous acid to remove the oxidized ruthenium from the dielectric structure based on a selectivity of the aqueous acid in dissolving the oxidized ruthenium;
selectively depositing a second ruthenium layer onto the first ruthenium layer by chemical vapor deposition to produce a thicker ruthenium layer; and
repeating the step of oxidizing and the step of contacting the oxidized ruthenium and an aqueous acid until a ruthenium layer having a thickness that is suitable for use as a ruthenium capping layer on at least one exposed surface of the copper wire embedded in the dielectric structure is achieved.

2. The method of claim 1, wherein the period of time during which selective nucleation of the ruthenium occurs on the surface of the copper wire is about 30 seconds.

3. The method of claim 1, wherein the ruthenium capping layer has a thickness of from about five nanometers to about 10 nanometers.

4. The method of claim 1, wherein the aqueous acid comprises a mineral acid.

5. The method of claim 1, wherein the aqueous acid comprises hydrofluoric acid.

6. The method of claim 5, wherein the hydrofluoric acid is diluted from about 10:1 to about 100:1 in deionized water.

7. The method of claim 1, wherein each step of selectively depositing a ruthenium layer by chemical vapor deposition is conducted in a vacuum chamber, and wherein the step of oxidizing any nucleated ruthenium present on the dielectric structure further comprises the step of:
removing the dielectric structure from the vacuum chamber to expose the dielectric structure to air to oxidize any nucleated ruthenium present on the dielectric structure.

8. The method of claim 1, wherein the step of oxidizing any nucleated ruthenium present on the dielectric structure further comprises the step of:
heating the dielectric structure in an oxygen-containing environment.

9. The method of claim 8, wherein the dielectric structure is heated in the oxygen-containing environment to a temperature of less than about 100 degrees Celsius.

10. The method of claim 1, wherein the step of oxidizing any nucleated ruthenium present on the dielectric structure further comprises the step of:
treating the dielectric structure with an aqueous oxidizing agent.

11. The method of claim 10, wherein the aqueous oxidizing agent comprises dilute hydrogen peroxide.

12. The method of claim 11, wherein the dilute hydrogen peroxide comprises 30 percent aqueous hydrogen peroxide diluted by about 100:1 in deionized water.

13. The method of claim 1, wherein the dielectric structure comprises a low-k dielectric.

14. The method of claim 13, wherein the low-k dielectric comprises SiCOH.

15. The method of claim 1, further comprising the step of: removing any oxide from exposed surfaces of the copper wire prior to performing the step of selectively depositing the first ruthenium layer.

16. The method of claim 1, wherein each step of selectively depositing a ruthenium layer further comprises the step of:
exposing the copper wire and dielectric structure to a precursor gas stream comprising a ruthenium precursor.

17. The method of claim 16, wherein the ruthenium precursor comprises Ru₃(CO)₁₂.
